(19) United States
(12) Patent Application Publication
(10) Pub. No.: US 2008/0093376 A1
(43) Pub. Date: Apr. 24, 2008

(54) Beverage dispenser

(76) Inventor: Craig Balkin, San Francisco, CA (US)

Correspondence Address: WILDMAN HARROLD ALLEN & DIXON LLP, 225 WEST WACKER DRIVE, SUITE 2800, CHICAGO, IL, 60606, US

(21) Appl. No.: 11/584,366

(22) Filed: Oct. 20, 2006

(51) Int. Cl. G07F 9/10

(52) U.S. Cl. 221/150 R; 221/154; 221/28; 221/67

(57) ABSTRACT

A beverage dispenser is disclosed and claimed. The unit comprises a housing, within which is mounted an impeller for engaging and urging beverage containers such as cans or bottles toward a housing opening. The impeller and the beverage containers are urged toward the housing by a biasing means such as a spring. Curved restraining formations such as fingers are located near the housing opening so as to engage the sides of the beverage containers and restrain them from movement out of the container until they are pulled out through a housing opening by the beverage dispenser unit operator.

### INVENTION FIELD

This invention relates to an apparatus that refrigerates and dispenses beverages contained in either a bottle or can.

### DESCRIPTION OF THE PRIOR ART

The advantage of small refrigeration units is the ability to put them in places where a large family sized refrigeration unit is not feasible. Hence smaller beverage refrigeration units became popular at college dorm rooms, living rooms, and workstations or office space.

These smaller prior beverage refrigeration units have no method to dispense the stored beverages to the consumer, thus requiring the consumer to bend down to retrieve the beverage from the containment unit. If the consumer doesn't want to bend down to retrieve the beverage, then the consumer is forced to put the refrigeration unit on top of a desk, dresser or otherwise waist-level piece of furniture. These prior refrigeration units also inhibit the ability to put the unit next to a couch or living room chair or under a desk at work.

Another disadvantage of the prior dispensers is that they are generally of a rectilinear box design allowing the user or consumer to keep food, as well as beverages within the unit. However, those consumers who enjoy keeping beverages in these small units have discovered that only a limited number of beverages can be kept in them because of shape of the interior space.

### SUMMARY OF INVENTION

The present invention is a refrigerated container that releases bottles and/or cans through the use of a spring loaded dispensing system. The unit is designed to house bottles and/or cans in either a side by side or staggered position inside the refrigerated unit.

The present invention has a novel insert which will allow the consumer to load the unit with either beverage cans or beverage bottles. In a preferred embodiment, two lanes or rows of beverages are provided, and each lane has the same sized bottles or cans. When opened, a consumer removes a beverage from the feeding tray and the spring forces the remaining beverages to the top of the closed unit for subsequent removal and consumption.

The novel unit can be opened by a latch attached to the front or back of the unit, or a rolling slide top, or through other mechanisms.

The present invention is thermostatically temperature controlled, and is cooled by a refrigeration pack located in the base of the unit. The unit can sit on a plastic base that will keep the unit in place on the floor.

### BRIEF DESCRIPTION OF THE DRAWINGS

FIG. 1 is a schematic view of the unit and bottles which may be disposed from the unit

FIG. 2 is a schematic view of the beverage container driver unit

FIGS. 3A and 3B are views of an alternate opening to dispense beverages

FIG. 4 is a view of another alternate opening to dispense beverages

FIG. 5 is a schematic view of the refrigeration system of the unit

### DETAILED DESCRIPTION OF THE DRAWINGS

Preferred embodiments of the present invention are described below with reference to the accompanying drawings, in which like reference numerals represent the same or similar elements.

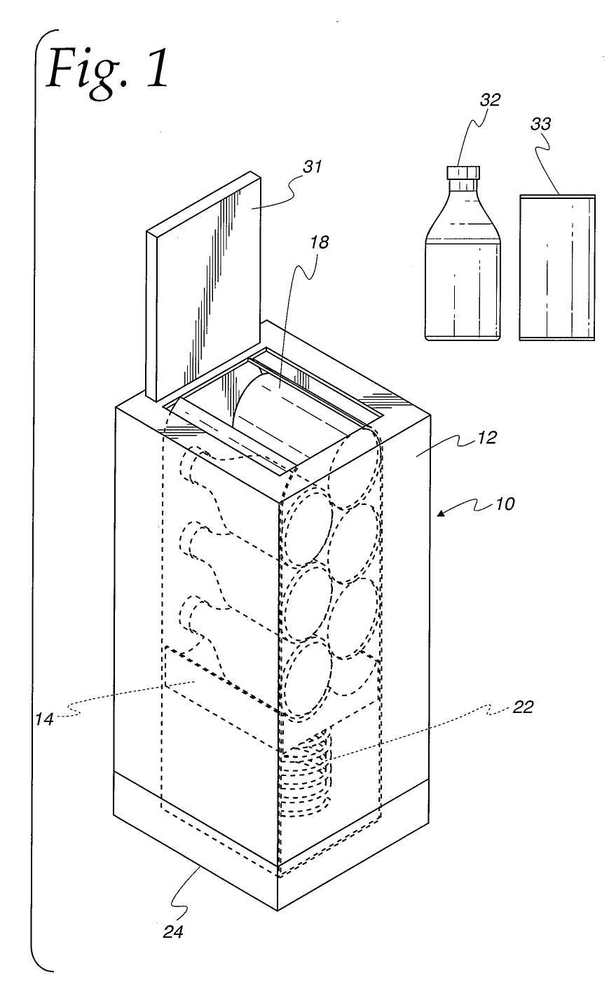

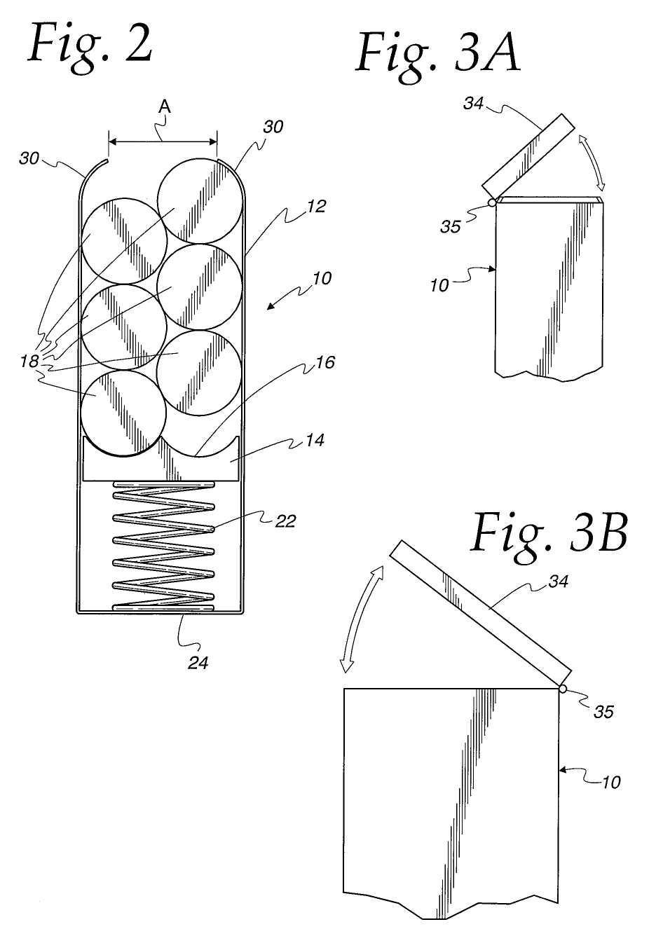

Turning to FIGS. 1 and 2, there is shown, in schematic form, an embodiment of the present invention. A beverage dispenser 10 comprises a housing 12 having a slanted impeller platform 14 which is provided with curved surfaces 16 adapted to engage and cradle both lanes or rows of the curved surfaces of beverage bottles, cans or other containers 18. A spring 22 or other biasing means of any known and convenient sort can be located between the housing bottom 24 and the platform 14 to urge the platform 14 and the beverage containers 18 in an outwardly (here, upwardly) direction.

Curved restraining formations such fingers 30 are located at the upper end of the housing 12. Preferably, these restraining formations 30 are shaped to engage portions of the sides of the beverage containers 18. As illustrated in FIG. 2, the containers 18 are thus restrained within the dispenser 10, but the containers 18 are pushed or urged toward the removal opening A. The removal opening A is larger than the containers 18, and so the containers 18 can be conveniently and manually removed from the beverage dispenser 10 by simply pulling a container 18 through the opening A. When a container 18 is so removed, the spring 22 and platform 14 urge the remaining containers toward the removal opening A.

Turning to FIG. 3B there is shown, in schematic form, a door 34 that opens via a latch 35 to permit the beverage container 18 out of the beverage dispenser 10. FIG. 3C shows, in schematic form a side view of a door 34 that opens via a latch 35. The latch 35 can be located at any convenient position on the housing 12.

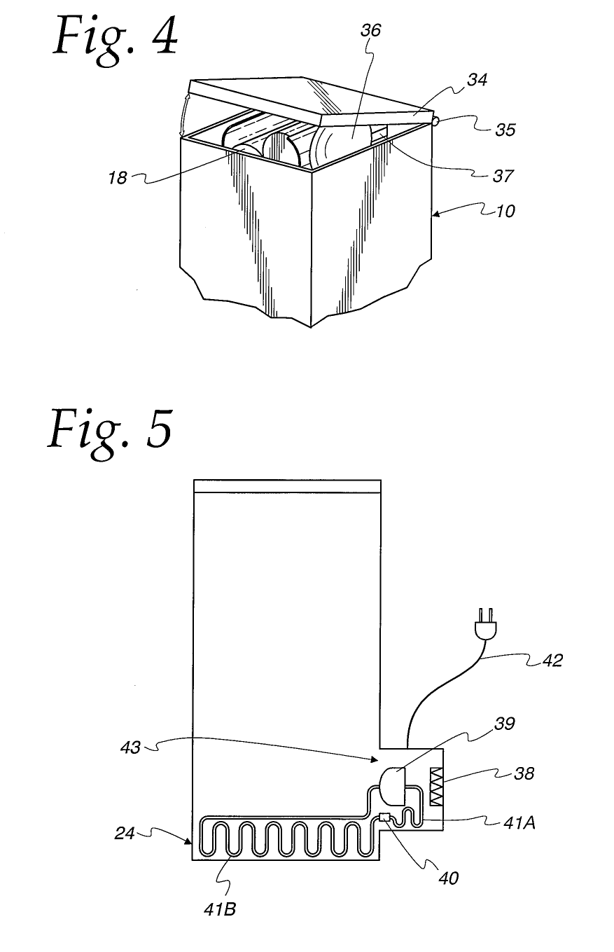

FIG. 4 shows, in schematic form, the open door 34 and the latch 35. An optional rubber bolt 37 will extend as the door 34 is opened further. The further the door 34 is opened, the further the rubber bolt 37 will extend. The rubber bolt 37 will make contact with the highest beverage can, 18 within the beverage dispenser 10, thereby forcing the beverage can 18 partially out of the unit 10.

Turning to FIG. 5 there is shown, in schematic form, the refrigeration unit 43 of the beverage dispenser 10. The refrigeration unit 43 houses the compressor 39, the fan 38, the heating exchanging coils 41A, the heat exchanging coils 41B, the expansion valve 40, and the electrical outlet plug 42. The compressor 39 is electronically operated through the current provided by the electrical outlet plug 42. The compressor 39 compresses the refrigerant gas by raising the refrigerant pressure and temperature allowing the heat exchanging coils 41A to dissipate the heat of pressurization. As the refrigerant cools it condenses in the heat exchanging coils 41A and then flows through the expansion valve 40. Once through the expansion valve 40, the refrigerant is moved from high pressure to low pressure in the heat exchanging coils 41B, thereby absorbing heat and making the beverage dispenser 10 cold. This cycle will repeat in order to continue keeping the beverage dispenser 10 cool at all times.

I claim:

1. A beverage dispenser unit comprising, in combination,
a housing,
an impeller adapted to engage and cradle beverage containers,
biasing means located between the housing and the impeller and adapted to urge the impeller toward a housing opening so as to urge the cradle beverage containers toward the opening,
and restraining formations near the housing opening and adapted to engage portions of the sides of the beverage containers so as to restraining container movement through the housing opening unless and until the beverage container is removed from the beverage dispenser unit.

2. A beverage dispenser unit according to claim 1, further comprising
a housing door and
a latch normally securing the housing door and the closed position.

3. A beverage dispenser unit according to claim 1, further comprising
a refrigeration unit for cooling the interior of the beverage dispenser unit.
